(19) United States
(12) Patent Application Publication
(10) Pub. No.: US 2016/0130162 A1
(43) Pub. Date: May 12, 2016

(54) WATER TREATMENT DEVICE USING HIGH VOLTAGE IMPULSE

(71) Applicant: Hoseo University Academic Cooperation Foundation, Asan-si (KR)

(72) Inventors: In-Soung CHANG, Cheonan-si (KR); June-Ho LEE, Seongnam-si (KR); Chan-Hyung CHO, Ansan-si (KR)

(73) Assignee: HOSEO UNIVERSITY ACADEMIC COOPERATION FOUNDATION, Asan-si (KR)

(21) Appl. No.: 14/550,609

(22) Filed: Nov. 21, 2014

(30) Foreign Application Priority Data
Nov. 6, 2014 (KR) 10-2014-0153659

(51) Int. Cl. C02F 1/48

(52) U.S. Cl. CPC C02F 1/48; C02F 2101/12

(57) ABSTRACT

A water treatment device using high voltage impulse is disclosed, the device including a high voltage impulse generator configured to generate a high voltage impulse by receiving an outside electric power source and operating in response to an outside control based on the applied outside electric power source, and a reactor configured to generate a reaction water by receiving the high voltage impulse from the high voltage impulse generator to process a source water.

### CROSS-REFERENCE TO RELATED APPLICATIONS

Pursuant to 35 U.S.C. §119(a), this application claims the benefit of earlier filing date and right of priority to Korean Patent Application No. 10-2014-0153659, filed on Nov. 06, 2014, the contents of which are all hereby incorporated by reference herein in its entirety.

### BACKGROUND OF THE DISCLOSURE

1. Field of the Disclosure

The present disclosure relates to a water treatment device, and more particularly, to a water treatment device using a high voltage impulse configured to inhibit formation of bromate that is generated in the course of disinfecting source water, using a high voltage impulse.

2. Discussion of the Related Art

The information disclosed in this Discussion of the Related Art section is only for enhancement of understanding of the general background of the present disclosure and should not be taken as an acknowledgement or any form of suggestion that this information forms the prior art already known to a person skilled in the art.

Ozone has a characteristic of not remaining in water along with a strong oxidizing power, and therefore an ozone disinfecting process is widely used as a disinfecting method of source water. However, when the source water is ozone-sterilized, bromate (BrO₃⁻) is generated if brome ions exist in the water. IARC (International Agency for Research on Cancer) has classified the bromated as a potential carcinogen and WHO (World Health Organization) has recommended that the concentration of bromate in edible water be at 0.01 mg/L(=10 ppb).

Although the generation of bromate can be minimized by adjusting injection concentration of ozone or disinfecting condition, there is a limit in inhibiting formation of bromate in the disinfecting process using ozone. As a result, researches on alternative disinfecting processes are required capable of inhibiting formation of disinfection by-products such as bromate, as cases have recently developed where bromate is generated exceeding a water quality level of source water during ozone disinfection.

### SUMMARY OF THE DISCLOSURE

This section provides a general summary of the disclosure, and is not a comprehensive disclosure of its full scope or all of its features.

Exemplary aspects of the present disclosure are to substantially solve at least the above problems and/or disadvantages and to provide at least the advantages below. Accordingly, an aspect of the present disclosure is to provide a water treatment device using a high voltage impulse configured to inhibit formation of bromate, and to effectively disinfect source water.

It should be emphasized, however, that the present disclosure is not limited to a particular disclosure, as explained above. It should be understood that other technical subjects not mentioned herein may be appreciated by those skilled in the art.

In one general aspect of the present disclosure, there is provided a water treatment device using a high voltage impulse, the water treatment device comprising:
a high voltage impulse generator configured to generate a high voltage impulse by receiving an outside electric power source and operating in response to an outside control based on the applied outside electric power source; and
a reactor configured to generate a reaction water by receiving the high voltage impulse from the high voltage impulse generator to process a source water.

In some exemplary embodiments, the high voltage impulse generator may include a high voltage generator configured to generate a high voltage by receiving the outside electric power source, a capacitor configured to be charged by receiving a high voltage from the high voltage generator, a switch configured to be switched by operating in response to the outside control, and an impulse generator configured to generate a high voltage impulse by receiving a high voltage transmitted through the switch.

In some exemplary embodiments, the water treatment device may further comprise:
a voltage measurer configured to measure a high voltage charged in the capacitor;
a driving controller configured to output a control signal for control of an operation of the high voltage impulse generator based on a state of the high voltage measured by the voltage measurer; and
a driver configured to control an operation of the switch by operating in response to the control signal.

In some exemplary embodiments, the switch may be a rotary gap switch, and the driver is a motor connected to the rotary gap switch for speed adjustment.

In some exemplary embodiments, the water treatment device may further comprise a display unit configured to display a current and a voltage by measuring the current and the voltage outputted from the high voltage impulse generator.

In some exemplary embodiments, the display unit may include a voltage distributor configured to measure a voltage outputted from the high voltage impulse generator, a current transformer configured to measure a current outputted from the high voltage impulse generator, and a waveform display unit configured to display a voltage change and a current change by receiving a voltage measured by the voltage distributor and a current measured by the current transformer.

In some exemplary embodiments, the reactor may include a reaction tank configured to accommodate a source water, a voltage applying terminal positioned inside the reaction tank and formed with a voltage applying electrode by receiving a high voltage impulse generated by the high voltage impulse generator, and a ground terminal positioned inside the reaction tank and formed with a ground electrode by being connected to a ground.

In some exemplary embodiments, the reactor tank may disinfect the source water inside the reaction tank by forming an electric field between the voltage applying electrode and the ground electrode in response to application of the high voltage impulse.

In some exemplary embodiments, each of the voltage applying electrode and the ground electrode may take a corner-rounded shape.

In some exemplary embodiments, each of the voltage applying electrode and the ground electrode may be processed with a multi-coated Teflon material.

In some exemplary embodiments, the reactor may further include a cooling water-flowing, cooling water pipe provided at an external side of the reaction tank.

The water treatment device using a high voltage impulse according to the present disclosure has an advantageous effect in that formation of bromate generated in the course of disinfecting the source water can be efficiently inhibited simultaneously along with the disinfection, in disinfecting source water using a high voltage impulse. Thus, application of the present disclosure to disinfection of source water can inhibit the formation of bromate generated in the course of disinfecting the source water.

Other exemplary aspects, advantages, and salient features of the disclosure will become more apparent to persons of ordinary skill in the art from the following detailed description, which, taken in conjunction with the annexed drawings, discloses exemplary embodiments of the invention.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinafter by way of illustration only, and thus are not limitative of the present invention, and wherein:

FIG. 1 is a block diagram illustrating a configuration of a water treatment device using a high voltage impulse according to an exemplary embodiment of the present disclosure;

FIG. 2 is a schematic view illustrating a water treatment device using a high voltage impulse according to an exemplary embodiment of the present disclosure;

FIG. 3 is a schematic view illustrating a shape of an electrode used in a reactor of a water treatment device using a high voltage impulse according to an exemplary embodiment of the present disclosure;

FIG. 4 illustrates photos that have observed a surface of an electrode coated once (a) and coated multiple times (b) that is used for a water treatment device using a high voltage impulse according to an exemplary embodiment of the present disclosure;

FIGS. 5A and 5B illustrate a graph when ozone disinfection was performed, and a graph when disinfection was made using a water treatment device using a high voltage impulse according to an exemplary embodiment of the present disclosure;

FIG. 6 is a schematic view illustrating, in chromatogram, changes in bromated concentration inside a specimen using a water treatment device using a high voltage impulse according to an exemplary embodiment of the present disclosure; and

FIG. 7 is a graph illustrating inactivation to E. Coli (colon bacterium) when a high voltage impulse was applied to BRr solution inoculated with E. Coli.

Additional advantages, objects, and features of the disclosure will be set forth in part in the description which follows, and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

It is to be understood that both the foregoing general description and the following detailed description of the present disclosure are exemplary and explanatory and are intended to provide further explanation of the disclosure as claimed.

### DETAILED DESCRIPTION

Various exemplary embodiments will be described more fully hereinafter with reference to the accompanying drawings, in which some exemplary embodiments are shown.

The present inventive concept may, however, be embodied in many different forms and should not be construed as limited to the example embodiments set forth herein. Rather, the described aspect is intended to embrace all such alterations, modifications, and variations that fall within the scope and novel idea of the present disclosure.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

As used herein, “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise.

It will be understood that when an element is referred to as being “connected” or “coupled” to another element, it can be directly connected or coupled to the other elements or intervening elements may be present. In contrast, when an element is referred to as being “directly connected” or “directly coupled” to another element, there are no intervening elements present.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise.

It will be understood that the terms “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof That is, the terms “including”, “includes”, “having”, “has”, “with”, or variants thereof are used in the detailed description and/or the claims to denote non-exhaustive inclusion in a manner similar to the term “comprising”.

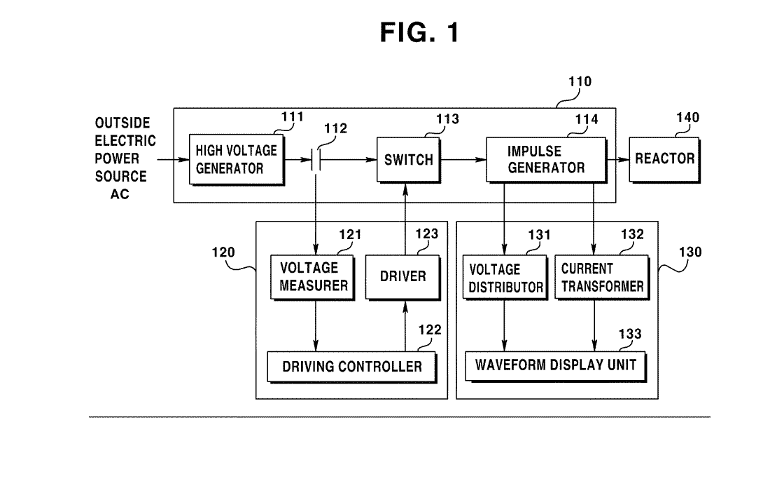

FIG. 1 is a block diagram illustrating a configuration of a water treatment device using a high voltage impulse according to an exemplary embodiment of the present disclosure.

The water treatment device using a HVI (High Voltage Impulse) (hereinafter referred to as ‘HVI water treatment device’ or simply ‘device’) according to an exemplary embodiment of the present disclosure can implement a water treatment using the HVI.

At this time, the HVI water treatment device can disinfect water free from generation of bromate by applying a HVI into water existent with bromide ions (Br).

Meantime, the HVI water treatment device may include a high voltage impulse generator (110), a controller (120), a display unit (130) and a reactor (140). This configuration is an example, and the present disclosure is not limited thereto.

The high voltage impulse generator (110) is configured to receive an electric power source from an outside electric power source (AC electric power source) in order to generate a high voltage impulse, where the high voltage impulse generator (110) is operated by control of the controller (120) to generate the high voltage impulse.

For example, the high voltage impulse generator (110) may include a high voltage generator (111) configured to generate a high voltage by receiving the outside electric power source, a capacitor (112) configured to be charged by receiving a high voltage from the high voltage generator (111), a switch (113) configured to be switched by operating in response to the outside control, and an impulse generator (114) configured to generate a high voltage impulse by receiving a high voltage transmitted through the switch (113). At this time, the switch (113) may be a rotary gap switch. But the present disclosure is not limited thereto.

Thus, the high voltage impulse generator (110), while generating and storing a high voltage by receiving an outside electric power source, generates a high voltage impulse based on the stored high voltage when an operation signal is applied from outside.

The controller (120) controls the high voltage impulse generator (110) to allow the high voltage impulse generator (110) to generate the high voltage impulse. At this time, the controller (120) may check a voltage state of the high voltage impulse generator (110) and control the high voltage impulse generator (110) based on the checked voltage state. For example, the controller (120) may include a voltage measurer (121), a driving controller (122) and a driver (123).

At this time, the voltage measurer (121) may measure a high voltage charged in a capacitor (112), the driving controller (122) may output a control signal for control of an operation of the high voltage impulse generator (110) based on a state of the high voltage measured by the voltage measurer (121), and the driver (123) may control an operation of the high voltage impulse generator (110) by operating in response to a control signal outputted from the driving controller (122).

For example, the driver (123) may be a motor connected to a switch (113) and switch the switch (113) by being driven in response to the control of the driving controller (122). At this time, the driver (123) is preferably a motor configured to adjust a speed.

Meanwhile, the display unit (130) may be configured to display a current and a voltage by measuring the current and the voltage outputted from the high voltage impulse generator (110). At this time, the display unit (130) may include a voltage distributor (131) configured to measure a voltage outputted from the high voltage impulse generator (110), a current transformer (132) configured to measure a current outputted from the high voltage impulse generator (110), and a waveform display unit (133) configured to display a voltage change and a current change by receiving a voltage measured by the voltage distributor and a current measured by the current transformer. For example, the display unit (130) may be an oscilloscope.

The reactor (140) may be configured to generate reaction water by processing source water, which is an object to be processed by application of high voltage impulse.

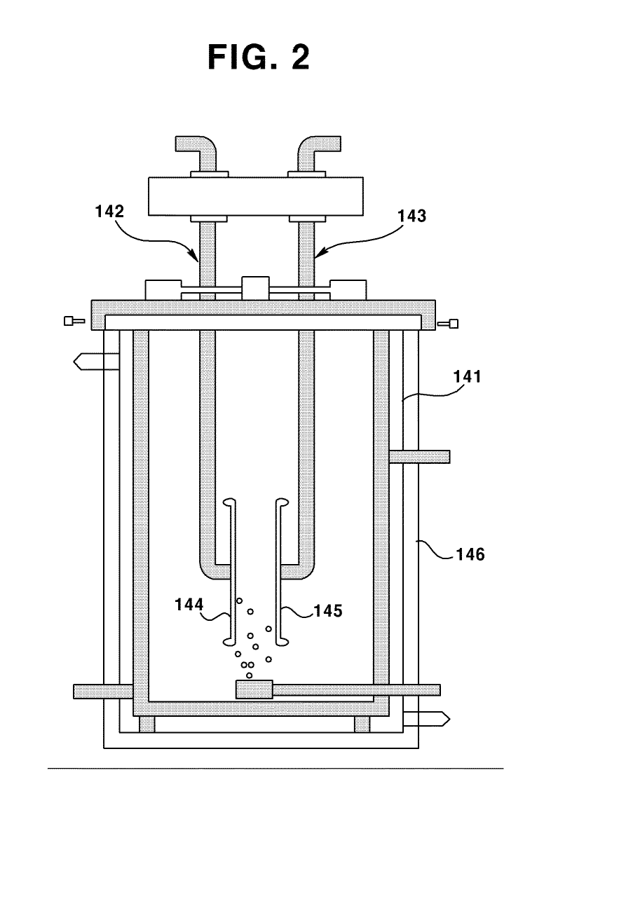

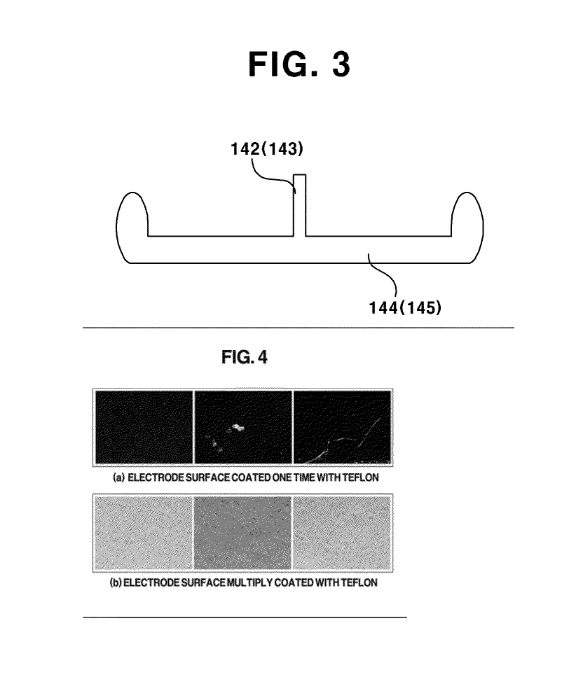

FIG. 2 is a schematic view illustrating a water treatment device using a high voltage impulse according to an exemplary embodiment of the present disclosure, and FIG. 3 is a schematic view illustrating a shape of an electrode used in a reactor of a water treatment device using a high voltage impulse according to an exemplary embodiment of the present disclosure.

Referring to FIG. 2, the reactor (120) may include a reaction tank (141) configured to accommodate a source water, and a voltage applying terminal (142) configured to form an electric field and a ground terminal (143). The reaction tank (141) is preferably made of a material through which an interior of the reaction tank (141) can be easily observed.

At this time, the voltage applying terminal (142) may be positioned inside the reaction tank (141) and applied with a high voltage impulse from the high voltage impulse generator (110) by being connected to the high voltage impulse generator (110). The ground terminal (143) may be positioned inside the reaction tank (141) to be connected to a ground.

Meantime, a distal end of the voltage applying terminal (142) may be formed with a voltage applying electrode (144) positioned within the source water, and a distal end of the ground terminal (143) may be formed with a ground electrode (145) positioned within the source water. The electric field may be formed between voltage applying electrode (144) and the ground electrode (145).

At this time, as shown in FIG. 3, it is preferable that each of the voltage applying electrode (144) and the ground electrode (145) takes a corner-rounded shape. When the each of the voltage applying electrode (144) and the ground electrode (145) takes a corner-rounded shape, an amount of corona generated from the corners can be reduced.

Furthermore, the electrodes (144, 145) may be coated, and materials used for coating are preferably selected in consideration of insulating property, non-stick performance, heat resistance, durability and chemical resistance. The electrode coating material must be excellent in insulating property to inhibit the flow of current by being submerged in source water, and must also withstand a high temperature.

Furthermore, electrode coating material must have durability strong enough not to be damaged on a surface of the electrode even for a long time of use, and must have a high chemical resistance not to be changed in quality and oxidized by microorganism. Furthermore, material for each of the voltage applying electrode (144) and the ground electrode (145) is preferably Teflon®, and more preferably processed with a multi-coated Teflon® material.

FIG. 4 illustrates photos that have observed a surface of an electrode coated once (a) and coated multiple times (b) that is used for a water treatment device using a high voltage impulse according to an exemplary embodiment of the present disclosure.

At this time, the photos of FIG. 4 show Teflon® coated surfaces of electrode observed in 40-times magnification using a microscope, and it can be noted that cracks and gaps observed from the multi-coated electrode surfaces have been considerably reduced over those coated once. In addition, the reactor (140) may further include a cooling water-flowing, cooling water pipe (146) provided at an external side of the reaction tank (141) to radiate heat generated in the course of experiment using the reactor (140).

In the foregoing, although configuration of the water treatment device using a high voltage impulse according to an exemplary embodiment of the present disclosure have been explained and described, existence of effect on inhibition of formation of bromate will be explained and described, based on experimental data using the water treatment device using a high voltage impulse according to an exemplary embodiment of the present disclosure.

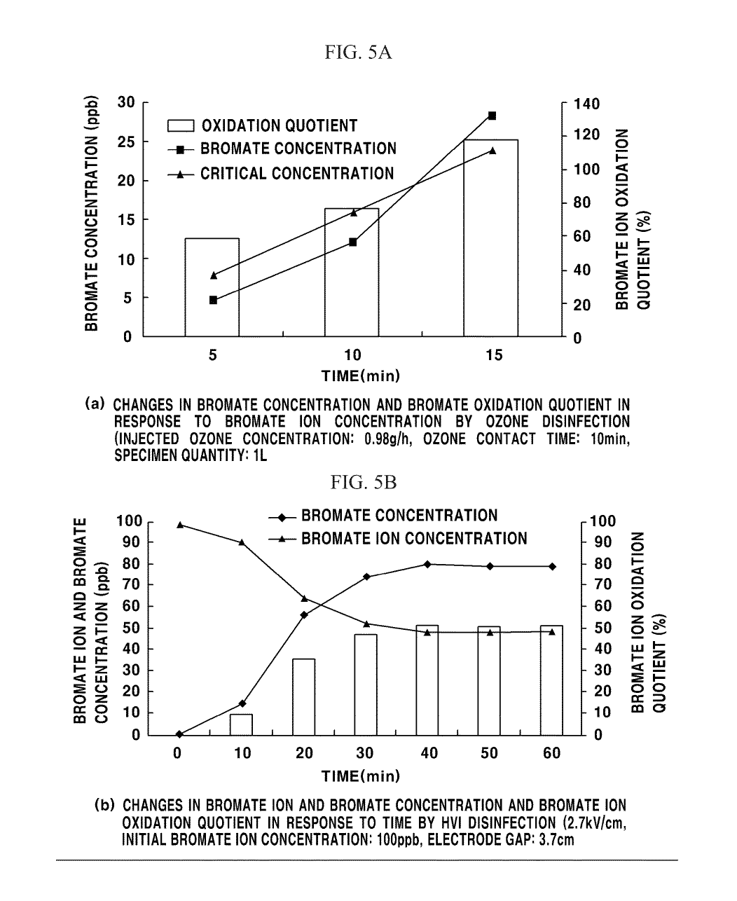

FIG. 5A and 5B illustrate a graph when ozone disinfection was performed, and a graph when disinfection was made using a water treatment device using a high voltage impulse according to an exemplary embodiment of the present disclosure.

The graph in FIG. 5(a) illustrates changes in bromate concentration and oxidation quotient in response to bromate ion concentration when disinfection was made with ozone, and the graph in FIG. 5(b) illustrates changes in bromate concentration and oxidation quotient in response to time when disinfection was made by the water treatment device using a high voltage impulse according to an exemplary embodiment of the present disclosure.

The graph in FIG. 5(a) illustrates a result in which ozone of 0.98 g/h concentration was injected into 1 liter of bromate ion solution for 10 minutes, where concentration of bromate ion solutions were respectively 5 ppb, 10 ppb, 15 ppb. At this time, concentrations were respectively 8 ppb, 16 ppb, 24 ppb when bromate ions of each concentration were all oxidized to bromate.

Concentrations of bromate generated after ozone disinfection were respectively 4.7 ppb, 12.3 ppb and 28.5 ppb, and 59%, 76% and 118% when expressed by oxidation quotients. It can be noted that the oxidation quotients by ozone was 59% at the minimum and 118% at the maximum, which shows that all oxidized to bromate.

The graph in FIG. 5(b) illustrates changes in bromate ions, bromate concentration and oxidation quotient in response to time when disinfection was made by application of high voltage impulse of electric field of 2.7 kV/cm to 1 liter of bromate ion region.

At this time, an initial bromated ion concentration was 100 ppb, a gap between electrodes was 3.7 cm, where bromated ion concentrations for 30 minutes were respectively shown with 14.9 ppb, 56.9 ppb and 75.8 ppb, which may be denoted in oxidation quotients with 9.3%, 35.6% and 47.4% respectively. The bromated ions after 30 minutes maintained oxidation quotient of approximately 51% and were no longer oxidized to bromate.

Thus, in view of the fact that the high voltage impulse disinfection has no longer shown oxidation at maximum 51% oxidation quotient, while the ozone disinfection has shown almost 100% bromated ion oxidation quotient, it can be noted that the HVI disinfection according to the present disclosure has a considerable effect on inhibition of formation of bromate.

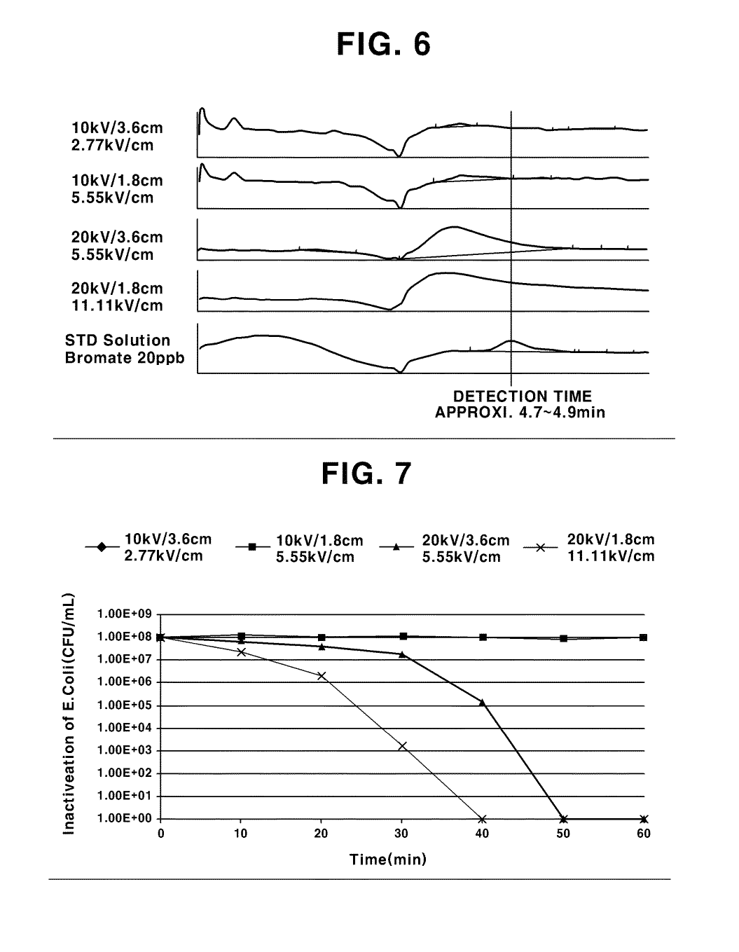

FIG. 6 is a schematic view illustrating, in chromatogram, changes in bromated concentration inside a specimen using a water treatment device using a high voltage impulse according to an exemplary embodiment of the present disclosure.

At this time, FIG. 6 illustrates a comparison result between bromated concentration measured after mutually different electric fields were applied to specimen for 60 minutes and standard solution of 20 ppb bromated concentration, where an experimental result of varying applied high voltages and distances between electrodes was compared with standard solution.

It can be confirmed from FIG. 6 that detection time of bromate shown from the standard solution was 4.7˜4.9 minutes, and no peaks were available generated from the same time zone in all four experiments applied with different electric fields, whereby it can be learned that no bromate is generated when a high 2 0 voltage impulse is applied to specimen for 60 minutes.

FIG. 7 is a graph illustrating inactivation to E. Coli when a high voltage impulse was applied to BRr solution inoculated with E. Coli.

At this time, a high voltage impulse (pulse length of was 4 μs with frequency of 200 Hz) was applied to 1 liter of KBr solution inoculated with E. Coli, where bromated ion concentration in the specimen was 50 ppb.

It was observed that E. Coli was still alive without being extinct when a voltage of 10 kV was applied, but 99.9% of initial E. Coli became extinct 30 minutes after application of high voltage impulse when a voltage of 20 kV had been applied with intensity of electric field of 5.55 kV/cm, and no E. Coli was observed after 50 minutes.

Furthermore, 99.999% of E. Coli became extinct 30 minutes after application of high voltage impulse when a voltage of 20 kV had been applied with intensity of electric field of 11.1 kV/cm, and no E. Coli was observed after 40 minutes.

As noted from the foregoing, it was confirmed that E. Coli inside specimen can be exterminated using a high voltage impulse.

The above-mentioned water treatment device using a high voltage impulse according to the present disclosure may, however, be embodied in many different forms and should not be construed as limited to the embodiments set forth herein. Thus, it is intended that embodiments of the present disclosure may cover the modifications and variations of this disclosure provided they come within the scope of the appended claims and their equivalents.

While particular features or aspects may have been disclosed with respect to several embodiments, such features or aspects may be selectively combined with one or more other features and/or aspects of other embodiments as may be desired.

What is claimed is:

1. A water treatment device using a high voltage impulse, the device comprising:
a high voltage impulse generator configured to generate a high voltage impulse by receiving an outside electric power source and operating in response to an outside control based on the applied outside electric power source; and
a reactor configured to generate a reaction water by receiving the high voltage impulse from the high voltage impulse generator to process a source water.

2. The water treatment device of claim 1, wherein the high voltage impulse generator includes:
a high voltage generator configured to generate a high voltage by receiving the outside electric power source;
a capacitor configured to be charged by receiving a high voltage from the high voltage generator;
a switch configured to be switched by operating in response to the outside control; and
an impulse generator configured to generate a high voltage impulse by receiving a high voltage transmitted through the switch.

3. The water treatment device of claim 2, further comprising:
a voltage measurer configured to measure a high voltage charged in the capacitor;
a driving controller configured to output a control signal for control of an operation of the high voltage impulse generator based on a state of the high voltage measured by the voltage measurer; and
a driver configured to control an operation of the switch by operating in response to the control signal.

4. The water treatment device of claim 3, wherein the switch is a rotary gap switch, and the driver is a motor connected to the rotary gap switch for speed adjustment.

5. The water treatment device of claim 1, further comprising a display unit configured to display a current and a voltage by measuring the current and the voltage outputted from the high voltage impulse generator.

6. The water treatment device of claim 5, wherein the display unit includes:
a voltage distributor configured to measure a voltage outputted from the high voltage impulse generator;
a current transformer configured to measure a current outputted from the high voltage impulse generator; and
a waveform display unit configured to display a voltage change and a current change by receiving a voltage measured by the voltage distributor and a current measured by the current transformer.

7. The water treatment device of claim 1, wherein the reactor includes:
a reaction tank configured to accommodate a source water;
a voltage applying terminal positioned inside the reaction tank and formed with a voltage applying electrode by receiving a high voltage impulse generated by the high voltage impulse generator; and
a ground terminal positioned inside the reaction tank and formed with a ground electrode by being connected to a ground.

8. The water treatment device of claim 7, wherein the reactor tank disinfects the source water inside the reaction tank by forming an electric field between the voltage applying electrode and the ground electrode in response to application of the high voltage impulse.

9. The water treatment device of claim 7, wherein each of the voltage applying electrode and the ground electrode takes a corner-rounded shape.

10. The water treatment device of claim 7, wherein each of the voltage applying electrode and the ground electrode is processed with a multi-coated Teflon material.

11. The water treatment device of claim 7, wherein the reactor further includes a cooling water-flowing, cooling water pipe provided at an external side of the reaction tank.
